(19) United States
(12) Patent Application Publication
(10) Pub. No.: US 2003/0091397 A1
(43) Pub. Date: May 15, 2003

(54) Conveying and metering apparatus for hard-to-pour granular materials

(75) Inventors: Achim Fingerle, Stuttgart (DE); Heiderose Stiller, Sersheim (DE)

Correspondence Address: CROWELL & MORING LLP, INTELLECTUAL PROPERTY GROUP, P.O. BOX 14300, WASHINGTON, DC, 20044-4300, US

(73) Assignee: Mann & Hummel ProTec GmbH, Ludwigsburg (DE)

(21) Appl. No.: 10/279,023

(22) Filed: Oct. 24, 2002

(30) Foreign Application Priority Data
Oct. 24, 2001 (DE) 101 52 576.1

(51) Int. Cl. B65G 53/08

(52) U.S. Cl. 406/53

(57) ABSTRACT

A conveyor device, particularly for silicone granulate, comprising a container and a fall shaft, positioned under the container, which ends in a trough of a screw feeder, the trough particularly having a level sensor and the position of the level sensor being adjustable in order to regulate the supply of the material to match the throughput of the apparatus.

### BACKGROUND OF THE INVENTION

The present invention relates to a conveying and metering apparatus for granular materials, especially for hard-to-pour granular materials such as silicone granulate. The apparatus of the invention can be used for charging a vertical injection molding machine and/or for metering out a hard-to-pour granular material for automated charging of a molding machine or the like.

Goth, U.S. Pat. No. 6,379,086 (=DE 199 12 277) discloses an apparatus for conveying plastic granulate which comprises a storage container, a device positioned in the storage container for loosening the plastic granulate, and a delivery device for direct or indirect transport of the granulate into an extruder reservoir. Through the loosening of the plastic granulate using an appropriate device, even hard-to-pour plastic granulates can be conveyed by the apparatus.

Furthermore, published Japanese patent application no. JP 59-115736 discloses a silicon granulate conveyor provided with a conveyor channel, which delivers the granulate from the container. Furthermore, this publication describes a weighing device, which enables metering of the granulate.

Hoyler, U.S. Pat. No. 4,940,568 (=DE 37 36 339) describes an arrangement for continuous melting of granulated silicon for a band drawing process. A turntable is provided for this purpose. A metering device, having a channel and a metering funnel, through which the appropriate quantities are supplied to the turntable, is positioned over this turntable.

Peveling, published German patent application no. DE 43 28 071 describes an apparatus for discharging hard-to-pour bulk material. Such bulk materials are problematic in that, particularly in a lower funnel-shaped region of the silo, bridges may form through bracing of bulk material between the funnel walls, which hinder or prevent discharge of the bulk material. In the container described, a circulation device is provided which removes the bulk material from a lower region of the silo and conveys it into a higher region of the silo.

It may be inferred from aforementioned citations that it is very problematic to reliably convey and meter hard-to-pour bulk materials. As a rule, expensive and complicated devices are needed to enable accurate metering of such granular materials.

### SUMMARY OF THE INVENTION

Accordingly, it is an object of the present invention to provide an improved granular material conveying and metering apparatus.

Another object of the invention is to provide a conveying apparatus which is simply constructed and yet operates reliably.

A further object of the invention is to provide a conveying apparatus which is suitable for charging a molding machine with a hard-to-pour granular material.

It is also an object of the invention to provide a conveying apparatus which is suitable for charging an injection molding machine with a silicone granulate.

These and other objects are achieved in accordance with the present invention by providing a conveyor system for conveying a metered amount of a granular material, said system comprising a container and a fall shaft positioned under the container and ending in a trough of a screw feeder, wherein the trough is provided with a level sensor and the level sensor is adjustable in position in order to match the supply of granular material to the trough with the throughput of the conveyor system.

The invention has the advantage that a fall shaft, which ends in a trough of a screw feeder, is positioned under the metering container. The trough has a level sensor. The position of the level sensor is adjustable in order to regulate the inventory of material in the trough to match the throughput of the apparatus. Particularly for hard-to-pour granulate, it is necessary to control the quantities to be supplied very precisely, so that no accumulations of material form, which could lead to a blockage of the system. Such blockages are effectively prevented by the arrangement according to the present invention.

In one embodiment of the present invention, the trough is provided with flexible and/or movable walls, which may be moved, for example, pneumatically or electro-mechanically.

In accordance with a further embodiment of the present invention, the screw conveyor is provided with a coreless spiral screw. This spiral screw also helps to prevent caking or agglomeration or clumping of the plastic granulate, so that this embodiment also contributes to problem-free conveyance being possible.

In a refinement of the present invention, the electrical current consumed by the drive for the spiral screw is continuously measured, and a start and/or stop signal for the rotation of the spiral screw is generated as a function of the current consumed, in order to ensure optimum metering to the feed screw of the vertical injection molding machine.

A slowly rotating stirring arm, to which rakes are attached, is provided in the storage container for loosening the granulate. This stirring arm ensures that the granulate in the lower region, i.e., in the discharge region, is continuously in motion and bridge formation and consequent plugging are avoided.

In another refinement of the apparatus, a grid-shaped hand protector is provided in the container. This protector is caused to oscillate via a piston vibrator and also contributes to loosening of the granulate.

Reliable metering of the granulate and/or transport of granulate in the conveyor device is achieved by use of an air driven pneumatic conveyor. A shutoff element is provided in the air supply line of the pneumatic conveyor line for adjusting the amount of conveyance air supplied and consequently the quantity of granular material which is conveyed. This shutoff device can be used to vary the supply of conveyance air as needed or desired.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWING

The invention will be described in further detail hereinafter with reference to an illustrative preferred embodiment shown in the accompanying drawing figure which is a schematic illustration of a conveying and metering apparatus for automatically charging a vertical injection molding machine with a granular material, such as a silicone granulate.

### DETAILED DESCRIPTION OF PREFERRED EMBODIMENTS

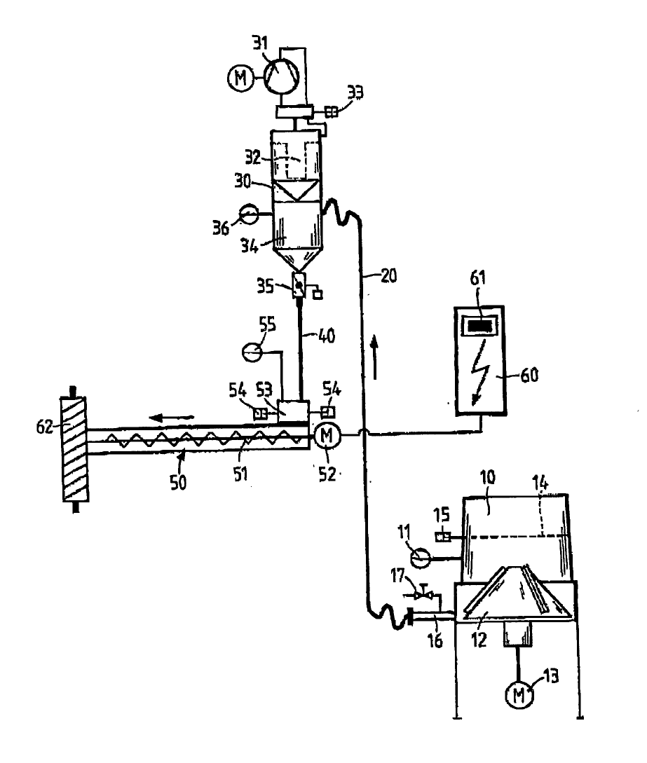

The schematic illustration in FIG. 1 includes a storage container 10, which has a level sensor 11, as well as a device 12, positioned at the bottom of the storage container, for loosening and discharging the silicone granulate disposed in the container. In the illustrated embodiment, the device for loosening and delivering the silicone granulate comprises a slowly rotating stirring arm, driven by a drive motor 13, to which stirring rakes are attached.

A grid-shaped hand protector 14 also is located in the storage container 10. A piston vibrator 15 is provided for causing grid 14 to oscillate during the material delivery.

A horizontally positioned suction tube 16 is located at the bottom of the storage container 10 for the material delivery. A manually operable shutoff element 17 is located on the air supply line leading to suction tube 16 for adjusting the supply of conveyance air. Alternatively, valve 17 could be an automatic valve.

The pneumatic conveyance is effected using a commercially available pneumatic conveyor device, as is known, for example, from German patent application no. DE 34 41 791 A1. Depending on the conveying capacity, a conveyor device having a fitted aspirator, i.e., integrated into the conveyor device, or a separate aspirator, may be used.

The suction tube 16 of the storage container 10 is connected by a conveyor line 20 to conveyor device 30. The conveyor device 30 comprises a conveyed material container 34, having a weight-loaded discharge flap 35, a filter 32, an aspirator 31, and a filter cleaning unit 33. Container 34 also may be provided with a level sensor 36 for regulating the flow of material into the container.

The conveyor device 30 discharges the silicone granulate through fall shaft 40 into the trough of a screw feeder 50. Trough 53 has a level sensor 55, which controls the filling of the trough. The position of the level sensor 55 is adjustable in order to optimally match the supply of granular material in the trough to the throughput of the apparatus. In order to avoid bridge formation in the trough, the trough has flexible or movable walls moved by actuators 54. The trough walls may be moved pneumatically or electro-mechanically. The movement frequency is continuously adjustable by the control unit 60 of the screw feeder 50.

The screw feeder 50 has a coreless spiral screw 51, driven by a motor 52, whose speed is regulated. Using the spiral screw 51, the silicone granulate is metered directly into the feed screw 62 of a vertical injection molding machine (not shown). The rotational speed of the spiral screw 51 is continuously adjustable at control unit 60 of the screw feeder 50.

The spiral screw is electrically driven, and the current consumption of the spiral screw drive is continuously measured and displayed at control unit 60 using a display unit 61. The spiral screw is started and stopped using a potential-free contact of the vertical injection molding machine, so that it may be ensured that the spiral screw 51 only delivers metered amounts of granular material when the feed screw 62 rotates.

In order to prevent clumping of the silicone granulate during the transfer from the spiral screw 51 into the feed screw 62, the spiral screw is stopped when the power consumption of the spiral screw drive exceeds an empirically determined limiting value. The spiral screw is automatically restarted after an adjustable time interval.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. A conveyor system for conveying a metered amount of a granular material, said system comprising a container and a fall shaft positioned under the container and ending in a trough of a screw feeder, wherein the trough is provided with a level sensor and the level sensor is adjustable in position in order to match the supply of granular material to the trough with the throughput of the conveyor system.

2. A conveyor system according to claim 1, wherein said granular material is a silicone granulate.

3. A conveyor system according to claim 1, wherein the trough has flexible or movable walls, which are flexed or moved pneumatically or electro-mechanically.

4. A conveyor system according to claim 1, wherein the screw feeder has a spiral screw, which meters the granular material directly into a feed screw of a vertical injection molding machine.

5. A conveyor system according to claim 4, wherein the spiral screw of the screw feeder is a coreless screw.

6. A conveyor system according to claim 4, wherein the spiral screw is electrically driven, further comprising means for measuring the electrical current consumption of the spiral screw drive and generating a start or stop signal for rotation of the spiral screw to regulate the metering of granular material to the feed screw.

7. A conveyor system according to claim 1, further comprising a granular material storage container, and a granular material loosening and delivering device arranged in said storage container, said loosening and delivering device comprising a rotatable stirring arm with protruding stirring rakes thereon and a drive motor for rotating said stirring arm.

8. A conveyor system according to claim 7, further comprising a grid-shaped hand protector arranged in the storage container, and a piston vibrator for causing the hand protector to oscillate.

9. A conveyor system according to claim 7, wherein the granular material is conveyed pneumatically from the storage container to the container above the fall shaft, and a flow regulating valve is provided in a pneumatic conveyor air supply line for adjusting introduction of conveyance air.

10. A conveyor system according to claim 9, wherein said flow regulating valve is manually operable.

11. A conveyor system according to claim 9, wherein said flow regulating valve is automatically operated.
